(19) United States
(12) Patent Application Publication
(10) Pub. No.: US 2013/0176353 A1
(43) Pub. Date: Jul. 11, 2013

(54) IMAGE DISPLAY APPARATUS AND METHOD

(71) Applicant: SAMSUNG ELECTRONICS CO., LTD., Suwon-si (KR)

(72) Inventors: Jae-sung PARK, Anyang-si (KR); Min-cheol HWANG, Seoul (KR); Jun-ho SUNG, Seoul (KR); Sang-un YUN, Seoul (KR)

(73) Assignee: SAMSUNG ELECTRONICS CO., LTD., Suwon-si (KR)

(21) Appl. No.: 13/737,058

(22) Filed: Jan. 9, 2013

(30) Foreign Application Priority Data
Jan. 10, 2012 (KR) 2012-0003177

(51) Int. Cl. G09G 3/20

(52) U.S. Cl. CPC G09G 3/2003
USPC 345/691; 345/690

(57) ABSTRACT

An image display apparatus and method are provided. The image display apparatus includes an image analyzing unit which inserts an insertion frame into an image of a color sequence and outputs an image of a color sequence in which the insertion frame is inserted, and changes a position of the insertion frame based on at least one dominant color and outputs an image in which the position of the insertion frame is changed, a display panel which receives the image of the color sequence, in which the insertion frame is inserted, from the image analyzing unit and displays the received image, and a backlight unit which receives information for the color sequence, in which the insertion frame is included, from the image analyzing unit and provides light of a color corresponding to the color sequence, in which the insertion frame is included, according to the received information.

### CROSS-REFERENCE TO RELATED APPLICATION

This application claims priority from Korean Patent Application No. 10-2012-0003177, filed on Jan. 10, 2012, in the Korean Intellectual Property Office, the disclosure of which is incorporated herein by reference in its entirety.

### BACKGROUND

1. Field

Apparatuses and methods consistent with the exemplary embodiments relate to an image display apparatus and method, and more particularly, to an image display apparatus and method which are capable of detecting a dominant color from an input image, that is, a unit frame image and adaptively varying a sequence for implementing colors according to the detection result.

2. Description of the Related Art

Liquid crystal displays (LCDs) as image display apparatuses are display apparatuses which apply an electric field to LC layers having dielectric anisotropy injected between two substrates, adjust an amount of light transmitted to the substrate by controlling an intensity of the electric field, and obtain desired images.

Most of the LCDs in the related art form a color filter layer including three primary colors, red (R), green (G), and blue (B) on one of two substrates, adjust an amount of light transmitted to the color filter layer, and display a desired color image. In other words, the LCDs transmit white light radiated from a light source to the color filter layer of RGB, adjust the amount of the light transmitted to the color filter layer of RGB, and synthesize R, G, and B colors, thereby displaying the desired color image.

In the LCDs which display a color image using white light and a three color filter layer, since corresponding pixels are necessary in R, G, and B regions, three times as many pixels are necessary as compared with monochrome displays. Therefore, fine fabrication technology of LC panels is needed to obtain high resolution images. In addition, there is a burden to form a separate color filter layer on a substrate and light transmittance of the color filter itself has to be enhanced.

In recent years, field sequential color (FSC) type LCDs using three color sources have been suggested and are referred to as color filter-less (CFL) type LCDs. The FSC type LCDs sequentially periodically turn on separated light sources for R, G, and B colors, provide color signals corresponding to each pixel in synchronization with lighting periods, and obtain full color images. The CFL type LCDs sequentially drive light emitting devices (LEDs) for R, G, and B colors in synchronization with LCs, accumulate colors, and finally represent colors. The most important factor for determining color expression in the CFL type LCDs is fast operation of the LC and color separation through accurate synchronization of operations between backlights and the LCD.

However, the CFL type causes the problem in which a color gamut is changed due to color mixing by a sequential driving method of the RGB backlights as compared with the general LCDs. In order words, when the LCs are not reacted within a fixed time and gradation is not normally represented, a color component of next sequence is interfered with a color component of a previous sequence and thus colors are mixed.

### SUMMARY

One or more exemplary embodiments may overcome the above disadvantages and other disadvantages not described above. However, it is understood that one or more exemplary embodiments are not required to overcome the disadvantages described above, and may not overcome any of the problems described above.

One or more exemplary embodiments is provided to an image display apparatus and method which analyze an input unit frame image to detect a dominant color of the unit frame image and change and drive a sequence for implementing colors according to the detection result.

According to an aspect of an exemplary embodiment, there is provided an image display apparatus. The image display apparatus may include: an image analyzing unit which inserts an insertion frame into an image of a color sequence which is divided into a R frame, a G frame, and a B frame with respect to an input image of a unit frame and outputs an image of a color sequence in which the insertion frame is inserted, and change a position of the insertion frame based on at least one dominant color in terms of a ratio in the unit frame and outputs an image in which the position of the insertion frame is changed; a display panel which receives the image of the color sequence, in which the insertion frame is inserted, from the image analyzing unit and displays the received image; and a backlight unit which receives information for the color sequence, in which the insertion frame is included, from the image analyzing unit and provides light of a color corresponding to the color sequence, in which the insertion frame is included, according to the received information.

When the display panel displays the insertion frame, the backlight unit may be driven to be a black (K) state.

When an input image of the unit frame is an image in which R, G, and B components are uniformly mixed, the analyzing unit may change the position of the insertion frame and arrange the insertion frame at the changed position every period in which the R frame, G frame, and B frame are repeated.

The display panel may divide the image in which the R, G, and B components are uniformly mixed into the R frame, G frame, and B frame and display images in sequence of GRW (white) B, GWRB, and WGRB. The backlight unit may provide light in sequence of GRK (black) B, GKRB, and KGRB.

The display panel may divide the image in which the R, G, and B components are uniformly mixed into the R frame, G frame, and B frame and display images in sequence of GRKB, GKRB, and KGRB. The backlight unit may provide light in sequence of GRKB, GKRB, and KGRB.

When it is determined that the dominant color includes a mixture of two components among the R, G, and B components, the image analyzing unit may change the position of the insertion frame and arrange the insertion frame at the changed position every period in which two unit frames, which generate the dominant color among the R, G, and B frames, are repeated.

When it is determined that the dominant color includes a monochrome color, the image analyzing unit may unchange the position of the insertion frame and output the insertion frame at an original position every period in which the monochrome unit frame is repeated.

The image analyzing unit may determine the color sequence in which the insertion frame is included according to a user's request.

The insertion frame may be arranged after a unit frame which emphasizes the dominant color.

According to another aspect of an exemplary embodiment, there is provided an image display method. The image display method may include: receiving an input image of a unit frame and detecting at least one dominant color in terms of a ratio of the colors in the received input image of the unit frame; outputting the input image of the unit frame by inserting an insertion frame into an image of a color sequence which is divided into R, G, and B frames, the outputting including outputting the input image of the unit frame by changing a position of the insertion frame inserted into the image of the color sequence according to the detected at least one dominant color; and receiving information for the color sequence in which the insertion frame is included and providing light of a color corresponding the color sequence in which the insertion frame is included according to the received information.

When the insertion frame is a white (W) image, the color of the light corresponding to the white image may be black (K).

The changing and outputting the position of the insertion frame inserted into the color sequence may include changing the position of the insertion frame and arranging the insertion frame at the changed position every period in which the R, G, and B frames are repeated when the input image of the unit frame is an image in which the R, G, and B components are uniformly mixed.

A display panel may divide the image in which the R, G, and B components are uniformly mixed into the R frame, G frame, and B frame and display images in sequence of GRW (white) B, GWRB, and WGRB. A backlight unit may provide light in sequence of GRK (black) B, GKRB, and KGRB.

A display panel may divide the image in which the R, G, and B components are uniformly mixed into the R frame, G frame, and B frame and display images in sequence of GRK B, GKRB, and KGRB. A backlight unit may provide light in sequence of GRKB, GKRB, and KGRB.

The changing and outputting the position of the insertion frame inserted into the image of the color sequence may include changing the position of the insertion frame and arranging the insertion frame at the changed position every period in which two unit frames, which generate the dominant color among the R, G, and B frames when it is determined that the dominant color includes a mixture of two components of the R, G, and B components.

The changing and outputting the position of the insertion frame inserted into the image of the color sequence may include unchanging the position of the insertion frame and outputting the insertion frame at an original position every period in which the unit frame of a monochrome is repeated when it is determined that the dominant color includes the monochrome.

The determining the color sequence in which the insertion frame is included may include determining the color sequence by a user's request.

The insertion frame may be arranged after a unit frame which emphasizes the dominant color.

According to the exemplary embodiments, an expansion effect of a full color gamut is obtained and thus users visually feel less the phenomenon in which colors are mixed and viewed.

Additional aspects and advantages of the exemplary embodiments will be set forth in the detailed description, will be obvious from the detailed description, or may be learned by practicing the exemplary embodiments.

### BRIEF DESCRIPTION OF THE DRAWING

The patent or application file contains at least one drawing executed in color. Copies of this patent or patent application publication with color drawing(s) will be provided by the Office upon request and payment of the necessary fee. The above and/or other aspects will be more apparent by describing in detail exemplary embodiments, with reference to the accompanying drawings, in which:

FIG. 1 is a block diagram illustrating a configuration of an image display apparatus according to an exemplary embodiment;

FIG. 2 is a schematic view illustrating a driving mechanism of an image analyzing unit of FIG. 1;

FIG. 3 is a view illustrating a driving example of a color sequence of a display panel and a backlight of FIG. 1;

FIG. 4 is a view illustrating a driving example of a color sequence in which three colors are emphasized;

FIG. 5 is a view illustrating a driving example of a color sequence in which two colors are emphasized;

FIG. 6 is a view illustrating a driving example of a color sequence in which a monochrome is emphasized;

FIG. 7 is a view illustrating a color coordinate gamut of a color sequence driving type according to an exemplary embodiment;

FIG. 8 is a view illustrating a driving example of a color sequence according to another exemplary embodiment; and

FIG. 9 is a view illustrating an image display method according to an exemplary embodiment.

### DETAILED DESCRIPTION OF THE EXEMPLARY EMBODIMENTS

Hereinafter, exemplary embodiments will be described in more detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

An exemplary embodiment may describe that an image display apparatus implements a unit frame image in sequence of GRKB (or GRWB) in a KRGB (or WRGB) mode and at the same time, sequentially backlights in synchronization with the color sequence in that the image display apparatus is operable as the KRGB (or WRGB) mode and useful in improving color mixing experimentally. However, the exemplary embodiment is not particularly limited thereto.

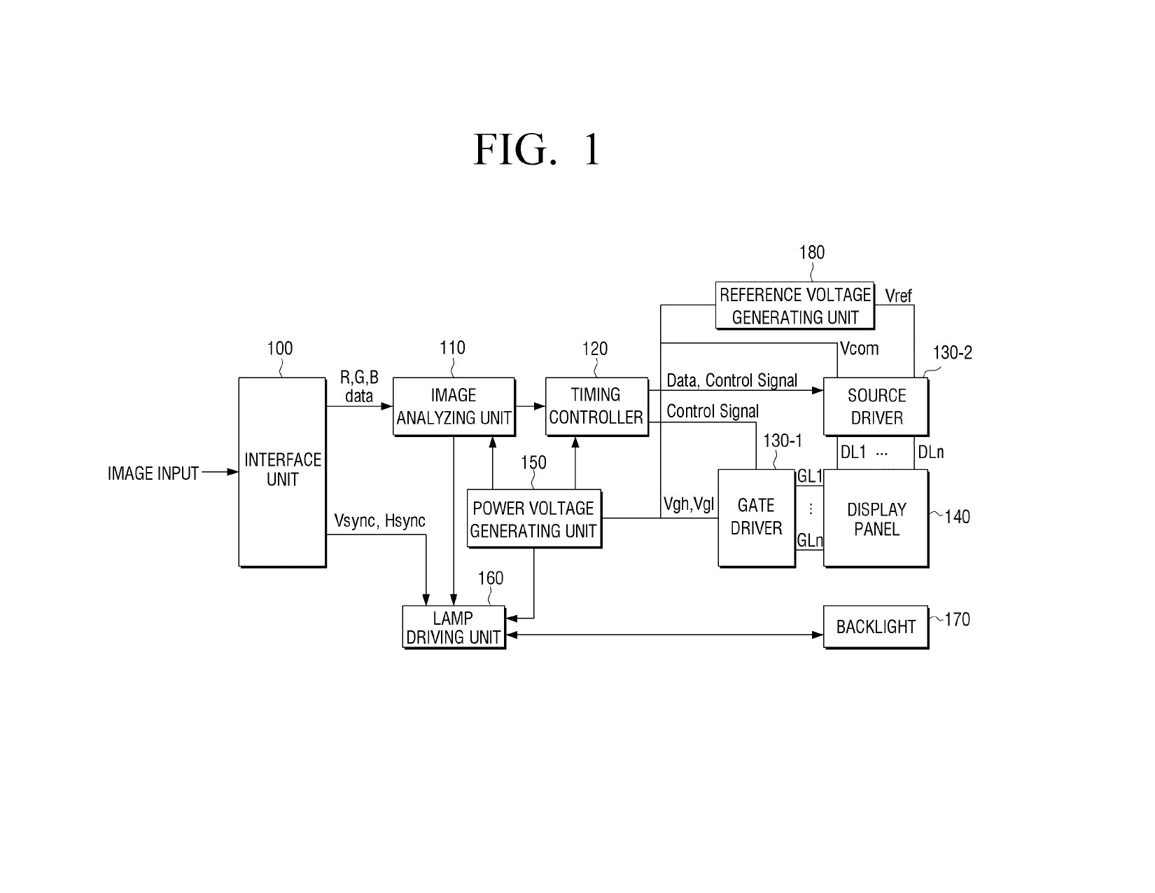

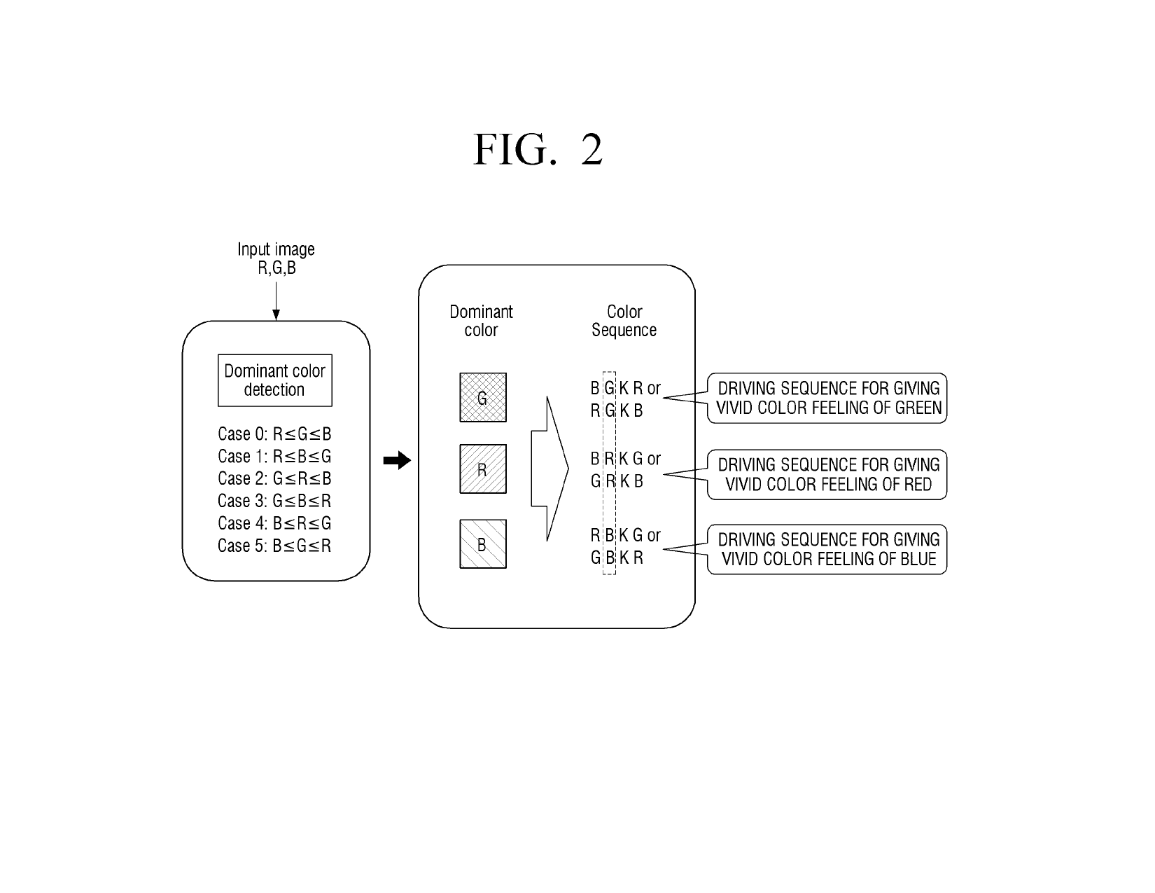

FIG. 1 is a block diagram illustrating a configuration of an image display apparatus according to an exemplary embodiment and FIG. 2 is a schematic view illustrating a driving mechanism of an image analyzing unit of FIG. 1.

As shown in FIG. 1, the image display apparatus according to an exemplary embodiment includes an interface unit 100, an image analyzing unit 110, a timing controller 120, gate driver 130-1 and source driver 130-2, a display panel 140, a power voltage generating unit 150, a lamp driving unit 160, a backlight 170, and a portion or whole of a reference voltage generating unit 180. Here, the interface unit 100 and the image analyzing unit 110 may be configured separately from the image display apparatus and the lamp driving unit 160 and the back light 170 may be referred to as a backlight unit.

The interface unit 100 is an image board such as a graphic card and performs functions to convert image data input from an external source into image data suitable for a resolution of the image display apparatus and output the converted image data. Here, image data may include 8-bit R, G, and B video data and interface unit 100 generates control signals such as a clock signal DCLK and vertical and horizontal synchronization signals Vsync and Hsync which are suitable for the resolution of the image display apparatus. The interface unit 100 provides the image data to the image analyzing unit 110 and provides the vertical and horizontal synchronization signals Vsync and Hsync and the like to the lamp driving unit 160 to enable the backlight 170 to be driven in synchronization with the vertical and horizontal synchronization signals Vsync and Hsync when R, G, W, and B unit frame images are implemented in the display panel.

The image analyzing unit 110 may receive image data of a unit frame, in which R, G, and B components are mixed, from the interface unit 100, generates four unit frame images, for example, G, R, W, and B unit frame images, and provides the generated unit frame images to the timing controller 120. In this case, the analyzing unit 110 analyzes the input image data to detect a dominant color (or a color dominated in a ratio), generates a color sequence in order of enhancing purity of the dominant color, for example, G, R, W, and B unit frame images according to the detection result or converts the generated color sequence of GRWB unit frame images, and output the generated color sequence or the converted color sequence to the timing controller 120. In this case, the lamp driving unit is also driven corresponding to the color sequence to cause the backlight 170 to be adaptively driven. The variable driving of the color sequence in the image analyzing unit 110 may be set in product fabrication and automatically performed or may be performed according to a user's option , that is, according to setting information selected by a user through a remote controller. Therefore, the driving method of the color sequence is not limited to the exemplary embodiment.

The image analyzing unit 110 receives a unit frame image in which the R, G, and B components are mixed and analyzes a plurality of frames input every frame or in a constant period of time in units of groups to detect a dominant color. A mode of the dominant color is determined from the detection result, for example, whether high purity in one color is represented as a mode which emphasizes a monochrome, whether high purity in two colors is represented as a mode which emphasizes cyan (C)/magenta (M)/yellow (Y), or whether high purity in all three colors is represented as a mode in which all the R, G, and B colors are emphasized. The image analyzing unit generates a unit frame image of a corresponding color sequence according to the determination result and provides the generated unit frame image to the timing controller 120 and provides the color sequence information, for example, mode information to the lamp driving unit 160.

For example, it is assumed that the unit frame image is in the mode in which a monochrome is emphasized as shown in FIG. 2 from the analysis result of the input RGB unit frame image in the image analyzing unit 110. The image analyzing unit 110 generates frame images in a color sequence for properly emphasizing color feeling of a corresponding color and outputs the generated frame images. That is, when the unit frame image is a G-emphasized image, the image analyzing unit 110 may generate the unit frame images in sequence of BGKR (or BGWR) or RGKB (or RGWB) as the color sequence or convert the sequence of the generated GRKB unit frame images and output the converted sequence. When the unit frame image is an R-emphasized image, the image analyzing unit 110 may arrange the R unit frame image before the K unit frame image and output the unit frame images in sequence of BRKG or GRKB as the color sequence. In addition, when the unit frame image is a B-emphasized image, the image analyzing unit 110 may output the unit frame images in sequence of RBKG or GBKR as the color sequence.

For clarity, although the case in which the monochrome is emphasized has been illustrated, when two colors are emphasized, for example, when the R and B colors are emphasized, the image analyzing unit 110 may alternatively generate and output unit frames in color sequences in which the G and R colors are emphasized. For example, when the image analyzing unit 110 drives the backlight 170 in sequence of RBKG in a first period, the image analyzing unit 110 may drive the backlight 170 in sequence of BRKB in a second period and in sequence of RBKG in a third period again. During the above process, when the driving of the color sequence in which the R and G colors are emphasized, the image analyzing unit 110 may return to the color sequence of GRKB which is an initial driving type.

When all the R, G, and B colors are emphasized, if the image analyzing unit 110 drives the backlight 170 in a sequence of BGKR in the first period, the image analyzing unit 110 may drive the backlight 170 in a sequence of BRKB in the second period and in a sequence of RBKG in the third sequence and the image analyzing unit 110 may alternatively perform operations of the first to third periods during a time in which corresponding colors are emphasized. During the above process, when the monochrome is emphasized, the image analyzing unit 110 may select one of sequences of BRKG, BKRG, and RBKG and operate according to the selection sequence. The process related to the operation will be described in detail later.

The timing controller 120 provides video data including R, G, K, and B unit frames provided from the image analyzing unit 110 to the source driver 130-2 and controls a video data output of the source driver 130-2 using a control signal so that the GRKB unit frames and unit frames in which a color sequence thereof are changed may be sequentially implemented in the display panel 140. The timing controller 120 controls the gate driver 130-1 to apply the gate on/off voltage provided from the power voltage generating unit 150 to the display panel 140 for each horizontal line. For example, when a first gate line GL1 is provided with a gate voltage, the timing controller 120 controls the source driver 130-2 to apply video data corresponding to a first horizontal line. The timing controller 120 turns on a second gate line GL2 and simultaneously turns off the first gate line and causes the video data corresponding to a second horizontal line to be provided to the display panel 140. In this way, G, R, K, and B unit frame images are sequentially displayed in an entire screen of the display panel 140. For example, when the display panel 140 displays an image of 240 frames per second, each of the G, R, K, and B unit frame images is displayed for a period of 4.16 ms.

The gate driver 130-1 receives gate on/off voltages Vgh/Vgl provided from the power voltage generating unit 150 and applies a corresponding voltage to the display panel 140 according to control of the timing controller 120. When the unit frame images are implemented in the display panel 140, the gate on voltage Vgh is sequentially provided from the first gate line GL1 to an n-th gate line GLn.

The source driver 130-2 converts serial video data provided from the timing controller 120 into parallel video data and converts digital data into an analog voltage and provides video data corresponding to each one horizontal line to the display panel 140 simultaneously and provides the video data every horizontal line sequentially. In addition, the source driver 130-2 may receive a common voltage Vcom generated in the power voltage generating unit 150 and a reference voltage Vref (or a gamma voltage) provided from the reference voltage generating unit 180. Here, the common voltage Vcom is provided to a digital/analog (D/A) converter in the source driver 130-2 to be used for gradation expression of a color image. That is, the video data provided from the timing controller 120 may be provided to the D/A converter and digital information of the video data provided to the D/A converter is converted into an analog voltage for gradation expression of colors and provided to the display panel 140.

The display panel 140 may include a first substrate, a second substrate, and a LC layer interposed between the first and second substrates. A plurality of gate lines GL1 to GLn and a plurality of data lines DL1 to DLn which are formed to cross each other and define pixel regions are formed on the first substrate and a pixel electrode is formed in each of the pixel regions at intersections of the plurality of gate lines and the plurality of data lines. In addition, a thin film transistor (TFT) is formed in a portion of each of the pixel regions, more specifically, a corner of each of the pixel regions. When the TFT turns on, LCs are twisted in response to a difference between a voltage applied to the pixel electrode of the first substrate and a common electrode of, for example, the second substrate and thus G, R, K, and B light of the backlight 170 may be sequentially transmitted. Here, to sequentially transmit the G, R, K, and B light, the display panel 140 of the exemplary embodiment may include a CFL display panel. That is, to form unit frames having various colors, the CFL display panel forms four unit frames which represents G, R, K, and B light with respect to the unit frames of the input image and implements images. In addition, the CFL display panel according to the exemplary embodiment may have a CSD type in which R, G, and B sub pixels are integrally one.

The power voltage generating unit 150 receives a nominal voltage from the outside, that is, an alternating current (AC) voltage of 110 V or 220 V and generates and output direct current (DC) voltages having various magnitudes. For example, the power voltage generating unit 150 may generate and provide voltages having various magnitudes, for example, a voltage of DC 15 V as the gate on voltage Vgh to the gate driver 130-1, a voltage of DC 24 V to the lamp driving unit 160, and a voltage of DC 12V to the timing controller 120. Further, the power voltage generating unit 150 may generate a driving voltage for the image analyzing unit 110 and provide the generated driving voltage to the image analyzing unit 110.

The lamp driving unit 160 converts a voltage provided from the power voltage generating unit 150 and provides the converted voltage to the backlight 170. The lamp driving unit 160 sequentially drives R, G, and B LEDs in a sequence of colors. The lamp driving unit 160 may form a black state by temporarily turning off the R, G, and B LEDs. The lamp driving unit 160 operates in synchronization with various color sequences of images displayed in the display panel 140 in relation with the image analyzing unit 110. In addition, the lamp driving unit 160 may include a feed back circuit configured to feed-back control a driving current of the R, G, and B LEDs to cause the light from the back light, for example, the R, G, and B LEDs to be uniformly provided.

The operation of the lamp driving unit 160 in relation with the image analyzing unit 110 will be described further now. The lamp driving unit 160 receives the analysis result, that is, color sequence information provided from the image analyzing unit 110 and adaptively controls the backlight 170 according to the color sequence information. Here, the color sequence information may be provided as mode information. For example, when a mode is set so that a R-emphasized mode is set to mode 1, a G-emphasized mode is set to mode 2, and the R and G-emphasized mode is set to mode 5, the image analyzing unit 110 provides information corresponding to “0001” as 4-bit information corresponding to mode 1 to the lamp driving unit 160 and thus the lamp driving unit 160 recognizes the color sequence for emphasizing the R color and controls the back light 170. In this way, when the image analyzing unit 110 provides the color sequence information, the image analyzing unit 110 may also provide time information for corresponding color sequence display periods and causes the backlight 170 to be driven accurately only for the color sequence display period. Various methods may be applied to drive the backlight and thus the method of driving the backlight is not limited to the exemplary embodiment.

The backlight 170 may include light emitting devices (LEDs) such as R, G, and B LEDs. In the exemplary embodiment, the backlight may be configured with any type such as a direct type in which the R, G, and B LEDs are disposed below the display panel 140 and an edge type in which the R, G, and B LEDs are disposed in an edge of the display panel 140. However, the backlight 170 according to an exemplary embodiment may include a backlight which sequentially provides R, G, and B light according to control of the lamp driving unit 160, generates a black state, and adaptively operates. Although the exemplary embodiment has briefly described operation of the lamp driving unit 160, a detailed operation of the lamp driving unit 160 will be described later.

The reference voltage generating unit 180 may be referred to as a gamma voltage generating unit and when a voltage of DC 10 V is received from the power voltage generating unit 150, the reference voltage generating unit 180 may divide the voltage into a plurality of voltages using division resistors again and provide the divided voltages to the source driver 130-2. Thereby, the source driver 130-2 may further divide the plurality of voltages provided from the reference voltage generating unit and represents 256 gradations for each of R, G, and B data. At the same time, the source driver 130-2 may represent white (W) data or black (K) data together with the gradation.

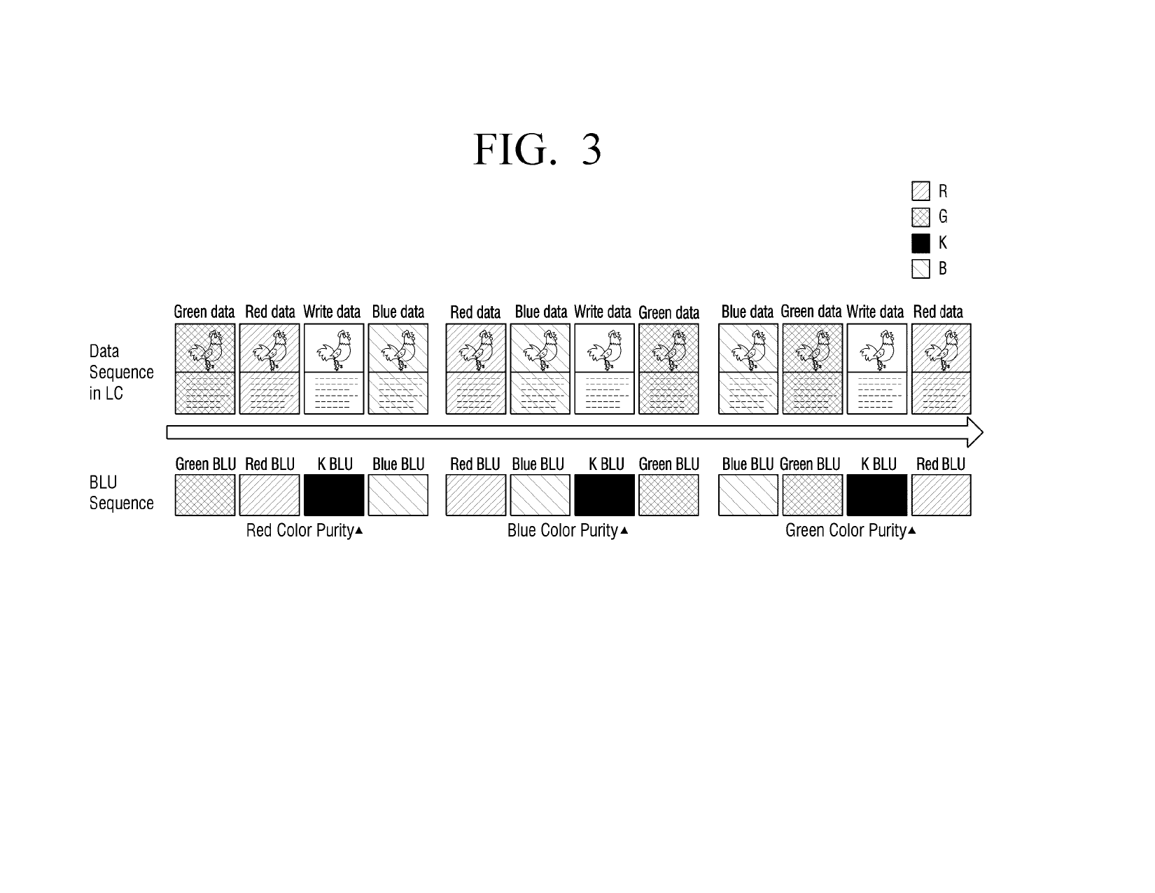

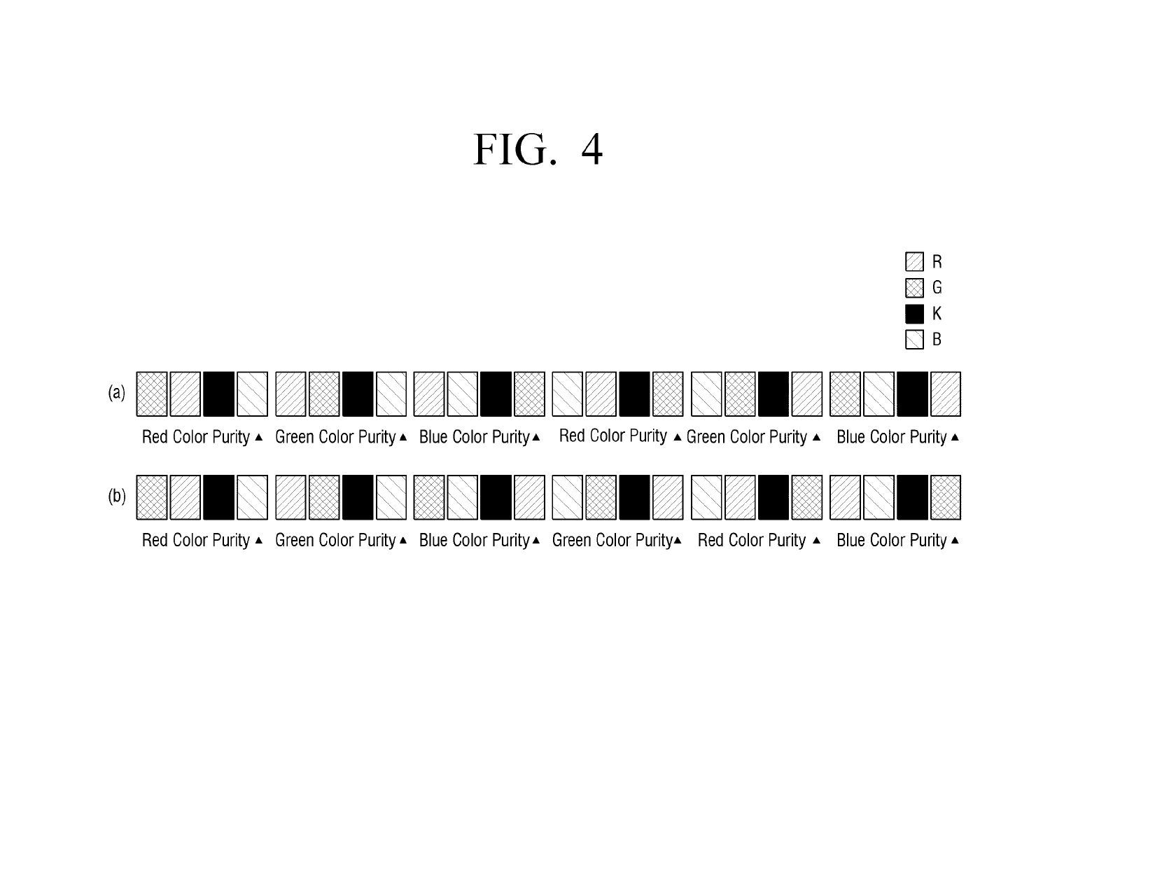

FIG. 3 is a view illustrating an example of driving a color sequence of the backlight and display panel of FIG. 3 and FIG. 4 is a view illustrating an example of driving a color sequence in which four colors are emphasized.

Referring to FIG. 3 with FIG. 1, for example, when it is assumed that the display panel 140 implements unit frame images in sequence of RGWB in the first period according to a color sequence provided from the image analyzing unit 110, the image analyzing unit 110 may output unit frame images having a color sequence of RBWG in the second period and unit frame images having a color sequence of BGWR in the third period.

The backlight 170 may output light in a sequence of GRKB corresponding to the unit frame images of GRWB in the first period according to the color sequence display in the display panel 140 and output light in a sequence of RBKG corresponding to the unit frame images of RBWG in the second period and the light in sequence of BGKR corresponding to the unit frame images of BGWR in the third period. Here, the black (K) state does not substantially output light according to an exemplary embodiment but turns off all LEDs of the back light 170. However, since the black state is obtained by providing all light in a normally-white mode, the black state may be formed using any method.

The image display apparatus assigns an opportunity which represents a color having high purity once in each period to obtain an expansion effect of a gamut for RGB full color through the display panel 140. As a result, the users may visually feel less the phenomenon in which colors is viewed to be mixed.

In addition, as shown in FIG. 4, the image display apparatus according to the exemplary embodiment may drive the backlight in synchronization with the various color sequences displayed in the display panel 140. FIG. 4(a) illustrates the case in which colors are emphasized with a constant pattern and FIG. 4(b) illustrates the case in which the constant pattern is varied.

Referring to FIG. 4(a), the display apparatus sequentially emphasizes the R, G, and B colors using the K color and the driving sequence is not changed. That is, when the R color is emphasized in the first period using the K color, the R color is emphasized in the fourth period and the G and B colors also periodically emphasized in corresponding periods like the G color. Meanwhile, referring to FIG. 4(b), first, the R, G, and B colors are sequentially emphasized using the K color and then the R, G, and B colors are randomly emphasized using the K color. That is, when the R color is emphasized in the first frame, the G color may be emphasized in the fourth frame.

The image display apparatus according to the exemplary embodiment may emphasize a dominant color once using the K color according to the dominant color of the input image and the entire driving pattern of the color sequence may be variously changed.

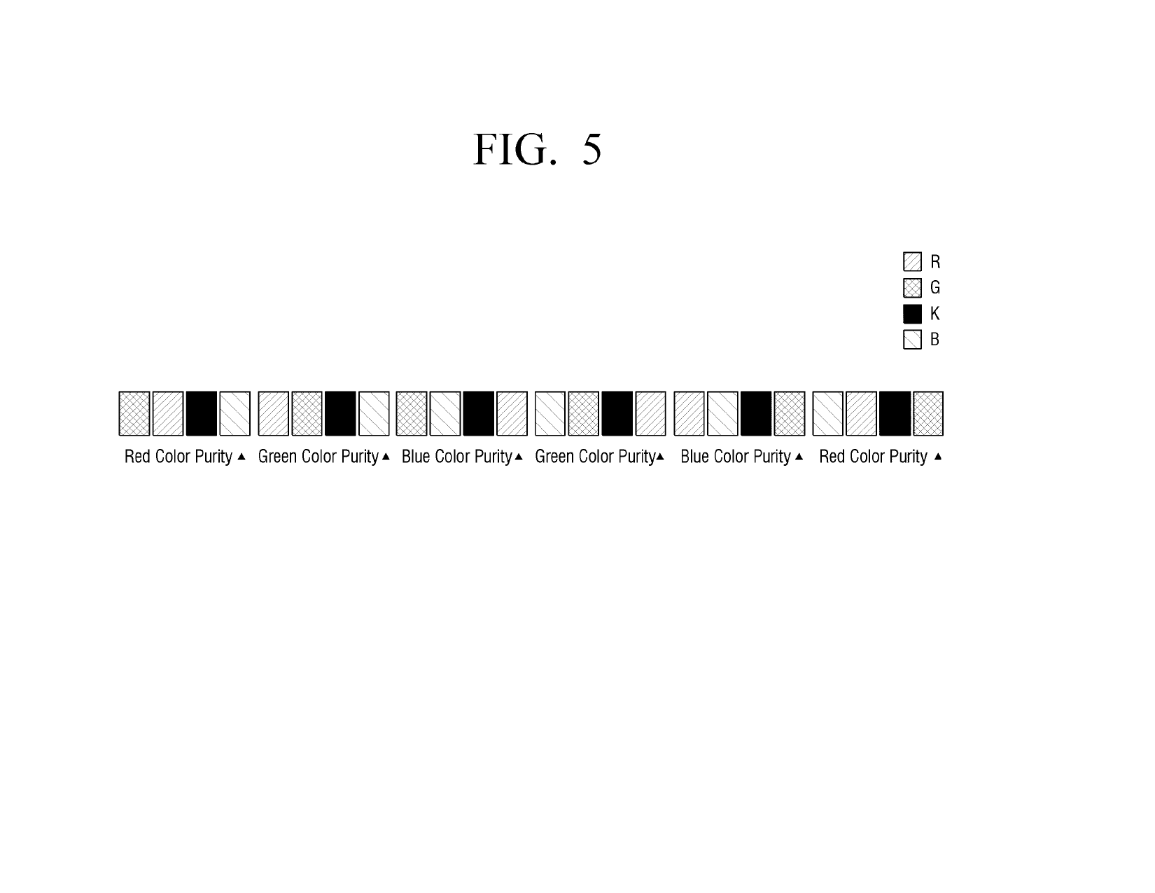

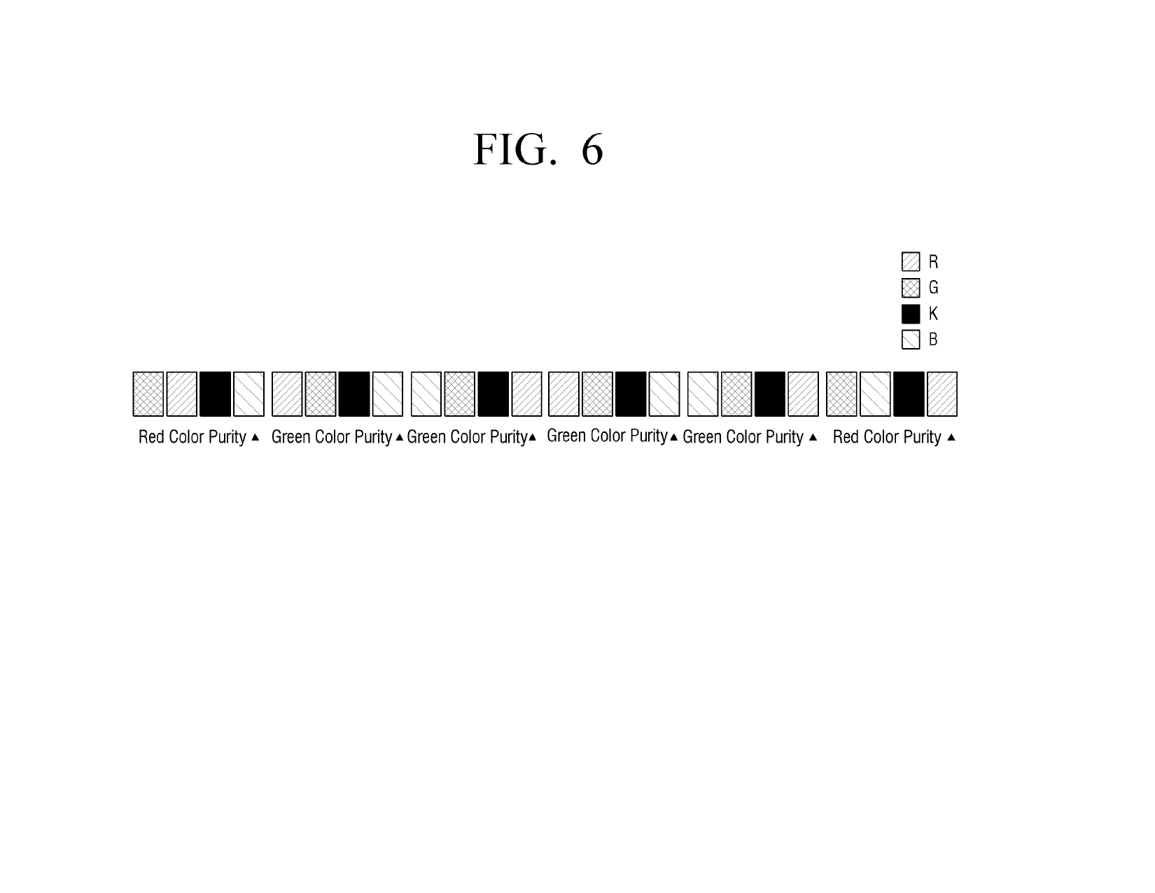

FIG. 5 illustrates a driving example of a color sequence in which two colors are emphasized and FIG. 6 is a driving example of a color sequence in which a monochrome is emphasized.

The image display apparatus according to an exemplary embodiment may analyze an input image and control the backlight to repeat a color sequence for emphasis of a mixed color when it is determined that the input image is an image in which the dominant color in a specific period is a mixture of two colors as the detection result.

Referring to FIG. 5, when the G color is emphasized once only in a period required for variable driving of a color sequence, for example, the first period, and the B color is emphasized in the second period, the image display apparatus may variably drive a color sequence in a manner in which the G color is emphasized once in the third period and the B color is emphasized in the fourth period again and drive the original color sequence after the variable driving. Here, the original color sequence driving method may denote the method of emphasizing three colors described in FIGS. 3 and 4. Stochastically, most of the input image may include an image in which three colors are mixed.

Meanwhile, when it is determined that a dominant color in a specific period is monochrome as the analysis result of the input image, the image display apparatus controls the backlight to repeat the color sequence for emphasis of the G color as shown in FIG. 6. In this case, the image display apparatus drives a color sequence in which the three colors are emphasized generally and then repeatedly drives a color sequence of the same pattern in which the G color is emphasized in the specific period.

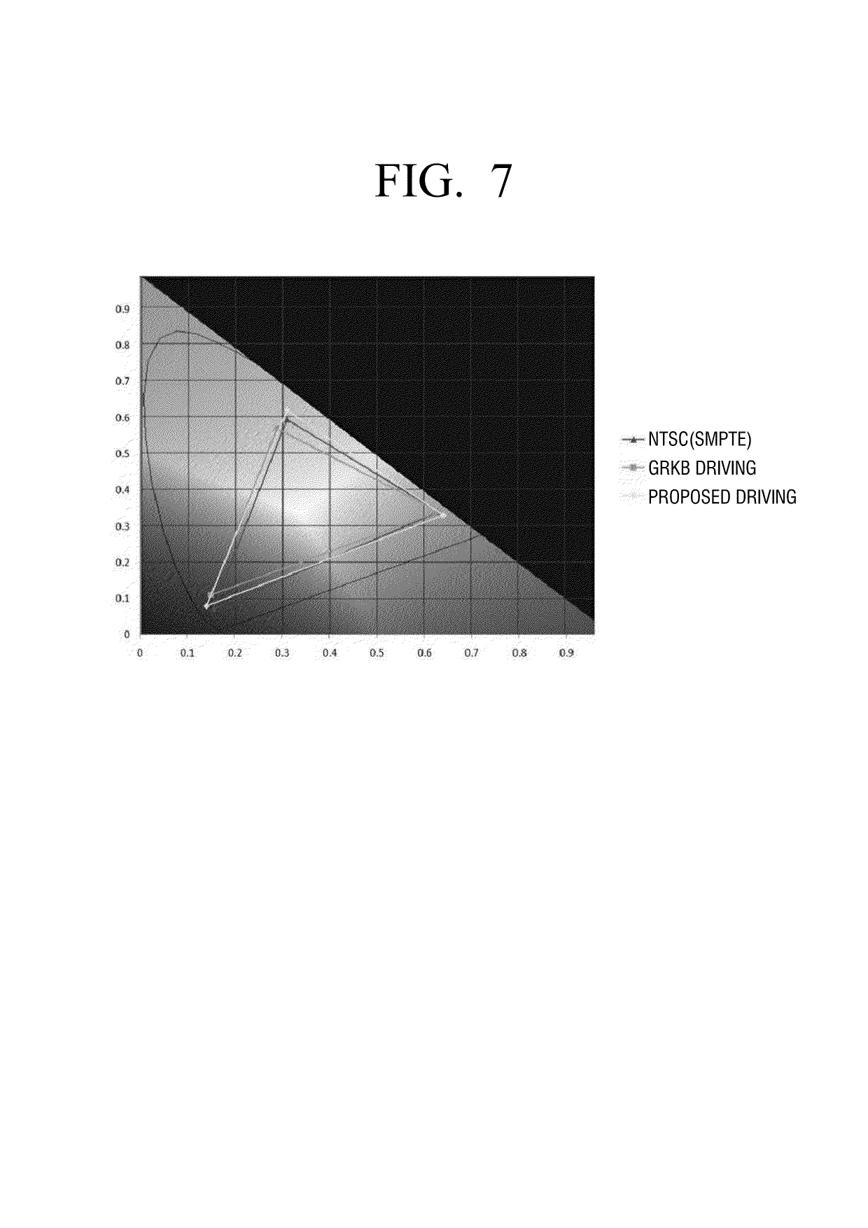

FIG. 7 is a view illustrating a color coordinate gamut of a color driving method according to an exemplary embodiment.

FIG. 7 comparatively illustrates a color gamut in the national television system committee (NTSC) (SMPET) type, a color gamut in GRKB driving, and a color gamut in the driving type of the exemplary embodiment, that is, the driving type having a variable color sequence. It can be seen from FIG. 6 that the color gamut in the variable driving method of the color sequence according to the exemplary embodiment is not accurately identical with the gamut in the NTSC driving type, but the color gamut in the variable driving method of the color sequence is closer to the color gamut in the NTSC as compared with the GRKB driving type.

In other words, it is shown that the variable driving method of the color sequence implements a natural color in all R, G, and B region which are region representing colors as compared with the GRKB driving method.

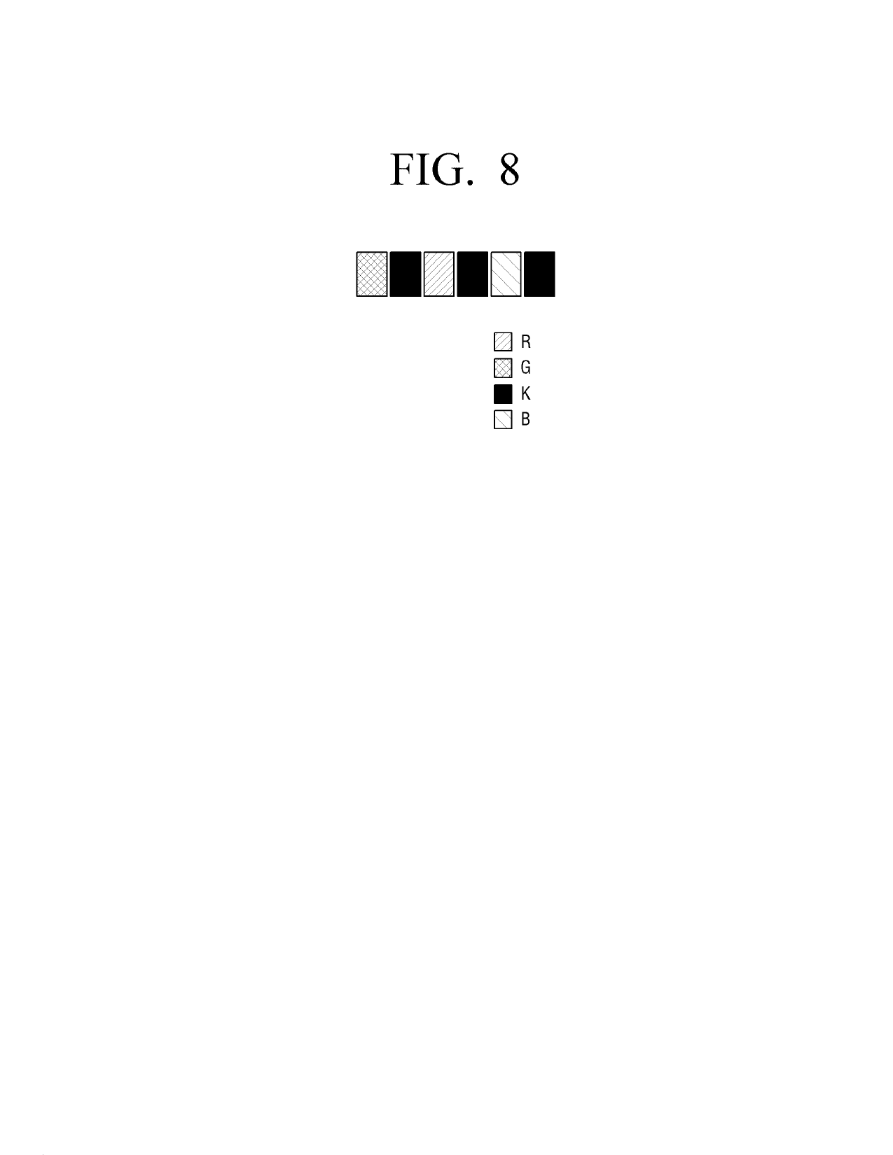

FIG. 8 is a view illustrating a driving example of a color sequence according to another exemplary embodiment.

The driving example of the color sequence has been described in FIGS. 3 to 6 under the assumption of the image display apparatus having a frame driving rate of 240 Hz and the driving example of the color sequence in FIG. 8 under the assumption of the image display apparatus having a frame driving rate of 480 Hz which is higher than the frame driving rate of 240 Hz.

Referring to FIG. 8, the image display apparatus according to another exemplary embodiment analyzes an input unit frame image in which R, G, and B colors are mixed into R, G, and B unit frame images and generates the analyzed R, G, and B unit frame, and may further insert the W (or K) unit frame image between unit frames and generate the unit frame images inserted with the W (or K) unit frame image. Therefore, the display apparatus may cause the backlight 170 to light in sequence of GKRKBK corresponding to a color sequence of GWRWBW displayed in the display panel 140.

In this case, the W light may be formed by turning off all LEDs of the backlight 170, but the exemplary embodiment is not limited thereto since the K (black) light may be formed by outputting all light of the R, G, and B in a normally-white mode.

Further, the image display apparatus according to another exemplary embodiment simultaneously inserts three K images as shown in FIG. 8, but may adjust the color sequence so that the two K images are inserted and the insertion position is variably changed.

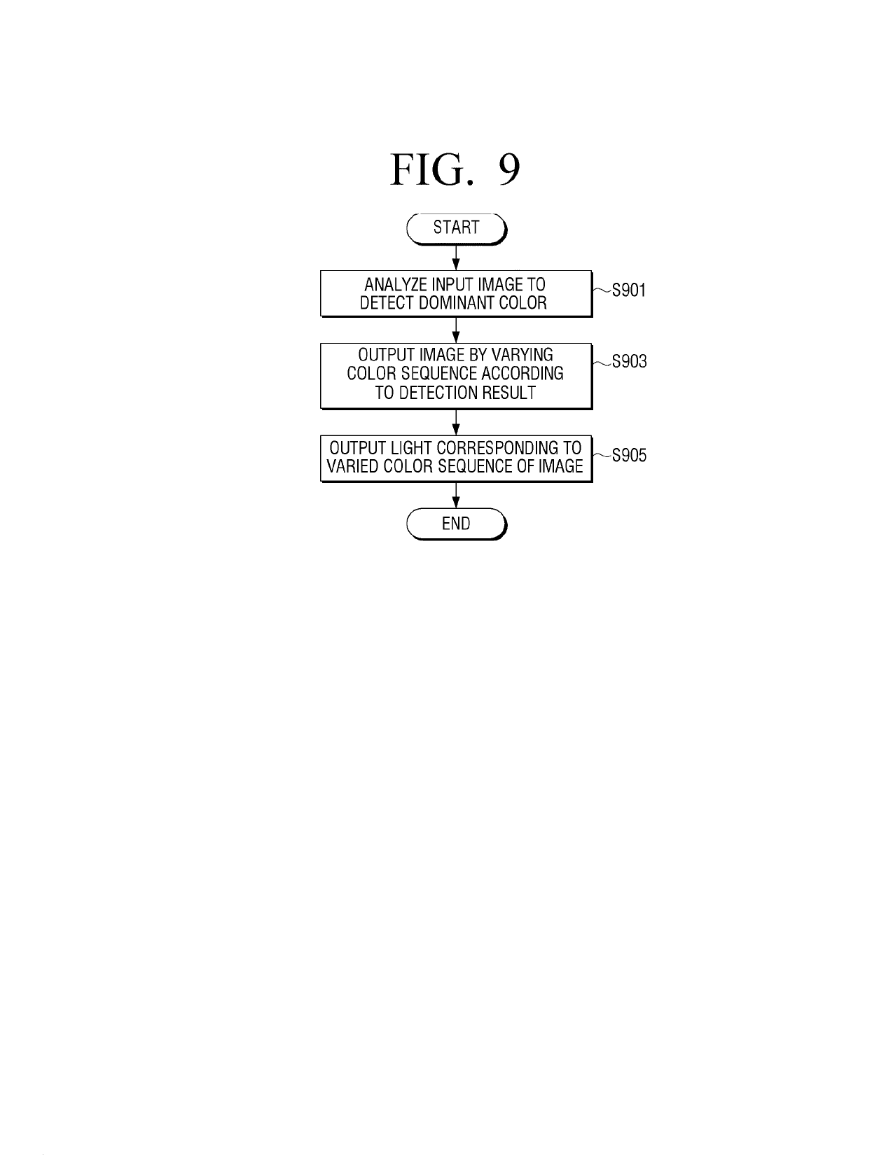

FIG. 9 is a view illustrating an image display apparatus according to an exemplary embodiment.

For clarity, referring to FIG. 9 with FIG. 1, the image display apparatus according to the exemplary embodiment analyzes an input unit frame image in which R, G, and B component are mixed to detect a dominant color in the unit frame image or in the unit frame image in units of group (operation S901). For example, the display apparatus may analyze all pixels of a unit frame to determine whether a monochrome color is dominant, two colors are mixed with each other, or all three colors are mixed. Therefore, the image display apparatus may determine whether a monochrome color is dominant, two colors are dominant, or all three colors are dominant in any specific period in which unit frames are implemented.

Subsequently, the image display apparatus varies a color sequence to emphasize a specific color according to the detection result and outputs an image (operation S903). Here, the term “vary” may denote that the driving type is changed in the specific period according to the detection result when it is assumed that the image display apparatus implements an image in a color sequence of GRWB which emphasizes all three colors. For example, an image may be implemented by changing the color sequence in a color sequence of GRWB in which the R color is emphasized in the specific period while implementing an image in the color sequence of GRWB. To implement the above-described function, the display apparatus first generates the image of GRWB and then outputs the image through the changing of the color sequence. Alternatively, the image display apparatus may directly generate and output the image of the color sequence corresponding to the detection result. Therefore, the term “vary” in the exemplary embodiment may be used as an expression to change a position in which the insertion image is inserted.

When the color sequence is changed and the image is output through the display panel 140, the display apparatus outputs light corresponding to the color sequence varied through the backlight 170 (operation S905). For example, when the image is displayed in color sequence of GRWB in the display panel 140, the backlight 170 sequentially outputs light in sequence of GRWB. When the color sequence is changed in a sequence of GWRB, the backlight 170 sequentially outputs light in a sequence of GKRB. The above-described operation has been described in detail and thus a detailed description thereof will be omitted.

According to the image display method, a change to display the high-purity color is evenly assigned once in each period to obtain an effect of expansion of the color gamut for the R, G, and B full colors through the display panel 140. Therefore, a phenomenon in which users visually feel less that the colors of the image are mixed, is reduced.

The image display method as described above may be implemented in the image display apparatus having the configuration of FIG. 1 as well as any image display apparatus having another configuration.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An image display apparatus, comprising:
an image analyzer which receives a unit frame of image data divided into a first color sequence of a red (R) frame, a green (G) frame, and a blue (B) frame, inserts an insertion frame into the first color sequence, outputs a first image of a second color sequence in which the insertion frame is inserted, changes a position of the insertion frame based on at least one dominant color in the unit frame and outputs a second image in which the position of the insertion frame is changed;
a display panel which receives the first image of the second color sequence, in which the insertion frame is inserted, from the image analyzer and displays the received image; and
a backlight unit which receives information for the second color sequence, in which the insertion frame is inserted, from the image analyzer and provides light of a color corresponding to the second color sequence, in which the insertion frame is inserted, according to the received information.

2. The apparatus as claimed in claim 1, wherein the backlight unit is driven to be a black (K) state when the display panel displays the insertion frame.

3. The apparatus as claimed in claim 1, wherein the analyzer changes the position of the insertion frame and arranges the insertion frame at the changed position every period in which the R frame, the G frame, and the B frame are repeated when an input image of the unit frame is an image in which R, G, and B components are uniformly mixed.

4. The apparatus as claimed in claim 3, wherein the display panel divides the image in which the R, G, and B components are uniformly mixed into the R frame, the G frame, and the B frame and displays images in sequences of GRW (white) B, GWRB, and WGRB, and the backlight unit provides light in sequence of GRK (black) B, GKRB, and KGRB.

5. The apparatus as claimed in claim 3, wherein the display panel divides the image in which the R, G, and B components are uniformly mixed into the R frame, the G frame, and the B frame and displays images in sequences of GRK(Black)B, GKRB, and KGRB and the backlight unit provides light in sequence of GRKB, GKRB, and KGRB.

6. The apparatus as claimed in claim 1, wherein, when the dominant color comprises a mixture of two components among the R, G, and B components, the image analyzer changes the position of the insertion frame and arranges the insertion frame at the changed position every period in which two unit frames, which generate the dominant color among the R, G, and B frames, are repeated.

7. The apparatus as claimed in claim 1, wherein, when the dominant color comprises a monochrome, the image analyzer unchanges the position of the insertion frame and outputs the insertion frame at an original position every period in which the monochrome unit frame is repeated.

8. The apparatus as claimed in claim 1, wherein the image analyzer determines the second color sequence in which the insertion frame is inserted according to a user's request.

9. The apparatus as claimed in claim 3, wherein the insertion frame is arranged after a unit frame which emphasizes the dominant color.

10. An image display method, comprising:
receiving an input image of a unit frame and detecting at least one dominant color from the received input image of the unit frame;
outputting the input image of the unit frame by inserting an insertion frame into an image of a first color sequence which is divided into red (R), green (G), and blue (B) frames, the outputting comprising outputting the input image of the unit frame by changing a position of the insertion frame inserted into the image of the first color sequence based on the detected at least one dominant color; and
receiving information for a second color sequence in which the insertion frame is inserted and providing light of a color corresponding to the second color sequence in which the insertion frame is inserted according to the received information.

11. The method as claimed in claim 10, wherein, when the insertion frame is a white (W) image, the color of the light corresponding to the white image is black (K).

12. The method as claimed in claim 10, wherein the outputting the input image of the unit frame by changing a position of the insertion frame comprises changing the position of the insertion frame and arranging the insertion frame at the changed position every period in which the R, G, and B frames are repeated when the input image of the unit frame is an image in which the R, G, and B components are uniformly mixed.

13. The method as claimed in claim 12, wherein a display panel divides the image in which the R, G, and B components are uniformly mixed into the R frame, the G frame, and the B frame and displays images in sequences of GRW (white) B, GWRB, and WGRB, and a backlight unit provides light in sequence of GRK (black) B, GKRB, and KGRB.

14. The method as claimed in claim 12, wherein a display panel divides the image in which the R, G, and B components are uniformly mixed into the R frame, the G frame, and the B frame and displays images in sequences of GRK B, GKRB, and KGRB, and a backlight unit provides light in sequence of GRKB, GKRB, and KGRB.

15. The method as claimed in claim 10, wherein the outputting the input image of the unit frame by changing a position of the insertion frame comprises changing the position of the insertion frame and arranging the insertion frame at the changed position every period in which two unit frames, which generate the dominant color among the R, G, and B frames when it is determined that the dominant color comprises a mixture of two components of the R, G, and B components.

16. The method as claimed in claim 10, wherein the outputting the input image of the unit frame by changing a position of the insertion frame comprises unchanging the position of the insertion frame and outputting the insertion frame at an original position every period in which the unit frame of a monochrome is repeated when it is determined that the dominant color comprises the monochrome.

17. The method as claimed in claim 10, wherein a determining of the color sequence in which the insertion frame is inserted is a determining of the color sequence by a user's request.

18. The method as claimed in claim 12, wherein the insertion frame is arranged after a unit frame which emphasizes the dominant color.

19. An image display apparatus comprising:
an interface which receives an input image comprising red (R), green (G), and blue (B) color components from an external source;
an image analyzer which analyzes frames of the input image to detect a dominant color and generates a unit frame image of a color sequence according to a result of the detecting;
a timing controller which receives the generated unit frame from the image analyzer, and
a lamp driver which receives information on the color sequence from the image analyzer and controls a backlight unit based on the color sequence information.

20. The apparatus of claim 19, wherein the color sequence information is mode information.
